(19) United States
(12) Patent Application Publication
(10) Pub. No.: US 2018/0014342 A1
(43) Pub. Date: Jan. 11, 2018

(54) Fuel Dispenser Having Vehicle Software and Information Distribution Capability

(71) Applicant: Gilbarco Inc., Greensboro, NC (US)

(72) Inventors: Thomas Hinz, Hamburg (DE); Edward Asbell Payne, Kernersville, NC (US); Rodger K. Williams, Siler City, NC (US)

(21) Appl. No.: 15/643,910

(22) Filed: Jul. 7, 2017

Related U.S. Application Data
(60) Provisional application No. 62/359,533, filed on Jul. 7, 2016.

(51) Int. Cl. H04W 76/02; B67D 7/04; G06F 9/445; G07F 13/02; H04W 12/06; H04W 84/18

(52) U.S. Cl. CPC H04W 76/023; G07F 13/025; H04W 12/06; B67D 7/04; G06F 8/65; H04W 84/18

(57) ABSTRACT

A fuel dispenser comprises fuel flow piping defining a flow path from a source of fuel toward a fueling nozzle. A plurality of fuel handling components are disposed along the fuel flow piping. Control electronics are in operative communication with the fluid handling components. The fuel dispenser further includes network circuitry operative to create an ad hoc wireless network with an adjacent vehicle and, after creation of such network, exchange security indicia with the vehicle that identifies the fuel dispenser as a trusted road side unit. Thereafter, the fuel dispenser facilitates a communication link with a remote server for bulk data transfer to the vehicle of information unrelated to a fueling transaction.

### PRIORITY CLAIM

This application is based upon and claims priority to U.S. provisional application Ser. No. 62/359,533, filed Jul. 7, 2016, which is relied upon and incorporated fully herein by reference for all purposes.

### FIELD OF THE INVENTION

The present invention relates generally to service stations at which fuel is dispensed. More particularly, the present invention relates to a fuel dispenser which is equipped to distribute software and information to a vehicle during a refueling process.

### BACKGROUND

Retail fueling environments usually include a plurality of fuel dispensers located in a forecourt area outside of a convenience store building. Typically, the fuel dispensers will each be equipped with pay-at-the-pump capability by which the customer can perform the fueling transaction using a user interface on the respective fuel dispenser. For example, the customer can present a credit or debit card using a card reader installed on the fuel dispenser's user interface to pay for the fuel without entering the store. Internally, the dispensers typically contain flow meters, pulsers, control electronics, valves, manifolds, and internal piping. Many of these components are subject to regulatory requirements to maintain a high degree of accuracy.

Modern vehicles are often equipped with anti-collision systems to lessen the occurrence of collisions between the vehicle and other objects, such as other vehicles, cyclists, pedestrians, etc. These systems rely on connectivity for supplying and receiving relevant parameters such as GPS coordinates, velocity, and trajectory. Notably, instead of a typical Wi-Fi Access Point (AP) with router forming a star-type connection, with all devices connected to the router being in full communication and therefore in exposure to other devices, these systems utilize Vehicle Ad-Hoc Networks (VANETs) to rapidly connect (e.g., typically within one second) on an ad hoc basis with other in range vehicles. As a result, the vehicles may exchange information regarding speed, direction and/or GPS position for purposes of collision avoidance. In addition, Road Side Units (RSUs) (which may be, for example, placed at traffic light installations) can serve as nodes in the VANET, facilitating communication among and with the vehicles. Various devices and methods regarding VANETs are shown and described in U.S. Pat. No. 9,276,743 (entitled “Probabilistic Key Distribution in Vehicular Networks with Infrastructure Support”) and U.S. Pat. No. 8,520,695 (entitled “Time-Slot-Based System and Method of Inter-Vehicle Communication”), the disclosures of which are incorporated fully herein by reference for all purposes.

It is conceivable that RSUs might also provide to the vehicles various software updates (including firmware updates) and/or larger file-size informational packets via secure-to-vehicle 802.11p connectivity. However, because a mobile target such as an automobile or truck is typically in motion, the nominal 300-foot effective range of geographically fixed 802.11p access points precludes sufficient dwell time with the vehicle for bulk data transfer activities (e.g., vehicle software updates and/or other information data distribution). Thus, traditional RSUs are not satisfactory for this purpose.

Sufficient dwell time does exist at OEM and larger non-OEM vehicle service locations to serve as a secure 802.11p access point; however, vehicle exposure is constrained to scheduled maintenance or repairs. Moreover, there is no assurance that the particular vehicle will undergo these services, as the vehicle owner may instead choose alternative vehicle service suppliers without an 802.11p access point, or may postpone or otherwise neglect the needed services.

The present invention recognizes and addresses various considerations of the prior art.

### SUMMARY OF CERTAIN ASPECTS

The present invention recognizes and addresses the foregoing considerations, and others, of prior art construction and methods. In this regard, certain exemplary and nonlimiting aspects of the present invention will now be described. These aspects are intended to provide some context for certain principles associated with the present invention, but are not intended to be defining of the full scope of the present invention.

Certain aspects of the present invention are directed to a fuel dispenser comprising fuel flow piping defining a flow path from a source of fuel toward a fueling nozzle. A plurality of fuel handling components are disposed along the fuel flow piping. Control electronics are in operative communication with the fluid handling components. The fuel dispenser further includes network circuitry operative to create an ad hoc wireless network with an adjacent vehicle and, after creation of such network, exchange security indicia with the vehicle that identifies the fuel dispenser as a trusted road side unit. Thereafter, the fuel dispenser facilitates a communication link with a remote server for bulk data transfer to the vehicle of information unrelated to a fueling transaction.

In some exemplary embodiments, the remote server comprises a server associated with a manufacturer of the adjacent vehicle. For example, the information unrelated to a fueling transaction may include software updates for the adjacent vehicle. In some exemplary embodiments, the network circuitry communicates with in range vehicles and determines whether one of the vehicles is the adjacent vehicle based on the location information. In some exemplary embodiments, the network circuitry creates a VANET with the adjacent vehicle. In some exemplary embodiments, the fuel dispenser is operative to monitor whether the communication link remains in effect.

Another aspect of the present invention provides a fuel dispensing environment comprising a plurality of fuel dispensers. Each of the dispensers has fuel flow piping defining a flow path from a source of fuel toward a fueling nozzle. A plurality of fuel handling components are disposed along the fuel flow piping. Control electronics are in operative communication with the fluid handling components. The fuel dispensing environment further includes an infrastructure to vehicle network device in communication with each of the fuel dispensers. The device includes network circuitry operative to create a wireless peer to peer network with vehicles in the forecourt and associate each such vehicle with one of the fuel dispensers. After creation of such network, the device exchanges security indicia with the vehicle identifying the infrastructure to vehicle network device as a trusted road side unit thereafter facilitating a communication link with a remote server for bulk data transfer to the vehicle of information unrelated to a fueling transaction.

A still further aspect of the present invention provides a method utilized at a fuel dispenser to wirelessly provide bulk data transfer of information in electronic form to an adjacent vehicle which is unrelated to a fueling transaction. One step of the method involves communicating with the vehicle when within communication range of the fuel dispenser. Another step of the method determines whether the vehicle is in a dispensing location adjacent to the fuel dispenser. If the vehicle is in the dispensing location, a VANET is established between the fuel dispenser and the vehicle. According to a further step, security indicia is provided to the vehicle identifying the fuel dispenser as a trusted road side unit. A communication link is established between the vehicle and a remote server to provide software updates for the vehicle.

Different systems and methods of the present invention utilize various combinations of the disclosed elements and method steps as supported by the overall disclosure herein. Thus, combinations of elements other than those discussed above may be claimed. Moreover, the accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a perspective view of an exemplary fuel dispenser in accordance with an embodiment of the present invention.

FIG. 2 is a diagrammatic representation of internal components of the fuel dispenser of FIG. 2 according to an embodiment of the present invention.

FIG. 3 shows additional detail regarding internal components of the fuel dispenser of FIGS. 1 and 2.

FIG. 4 is a diagrammatic elevational representation of a fuel dispenser configured to create an ad-hoc network with one or more vehicles adjacent thereto by which bulk data may be transferred to the vehicle(s).

FIG. 5 shows additional exemplary detail regarding the vehicle electronics of FIG. 4.

FIG. 6 is a diagrammatic representation showing communication between a vehicle manufacturer server and the vehicle via the fuel dispenser.

FIG. 7 is a flowchart showing exemplary methodology in accordance with the present invention from the standpoint of the fuel dispenser.

FIG. 8 is a flowchart showing exemplary methodology in accordance with the present invention from the standpoint of the vehicle.

FIG. 9 is a flowchart showing exemplary methodology in accordance with the present invention from the standpoint of the manufacturer server.

FIG. 10 is a diagrammatic representation of a fuel dispensing environment including a device separate from the fuel dispensers for creating ad hoc peer-to-peer networks with the vehicles to be refueled.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Some embodiments of the present invention may be particularly suitable for use with a fuel dispenser in a retail service station environment, and the below discussion will describe some preferred embodiments in that context. However, those of skill in the art will understand that the present invention is not so limited. In fact, it is contemplated that embodiments of the present invention may be used with any fluid dispensing environment and with other fluid dispensers. For example, embodiments of the present invention may also be used with diesel exhaust fluid (DEF) dispensers, compressed natural gas (CNG) dispensers, and liquefied petroleum gas (LPG) and liquid natural gas (LNG) applications, among others.

Examples of retail fueling environments, fuel dispensers, and user interfaces for fuel dispensers are provided in U.S. Pat. No. 6,435,204 (entitled “Fuel Dispensing System”), U.S. Pat. No. 5,956,259 (entitled “Intelligent Fueling”), U.S. Pat. No. 5,734,851 (entitled “Multimedia Video/Graphics in Fuel Dispensers”), U.S. Pat. No. 6,052,629 (entitled “Internet Capable Browser Dispenser Architecture”), U.S. Pat. No. 5,689,071 (entitled “Wide Range, High Accuracy Flow Meter”), U.S. Pat. No. 6,935,191 (entitled “Fuel Dispenser Fuel Flow Meter Device, System and Method”), U.S. Pat. No. 7,289,877 (entitled “Fuel Dispensing System for Cash Customers”), U.S. Pat. No. 8,438,064 (entitled “Payment Processing System for Use in a Retail Environment having Segmented Architecture”), and U.S. published patent application nos. 20090048710 (entitled “Fuel Dispenser”), 20090265638 (entitled “System and Method for Controlling Secure Content and Non-secure Content at a Fuel Dispenser or other Retail Device”), 20110185319 (entitled “Virtual PIN Pad for Fuel Payment Systems”), 20130059694 (entitled “Fuel Dispenser Application Framework”), and 20130103190 (entitled “Fuel Dispenser User Interface System Architecture”). The entire disclosure of each of the foregoing patents and applications is hereby incorporated by reference in their entirety for all purposes.

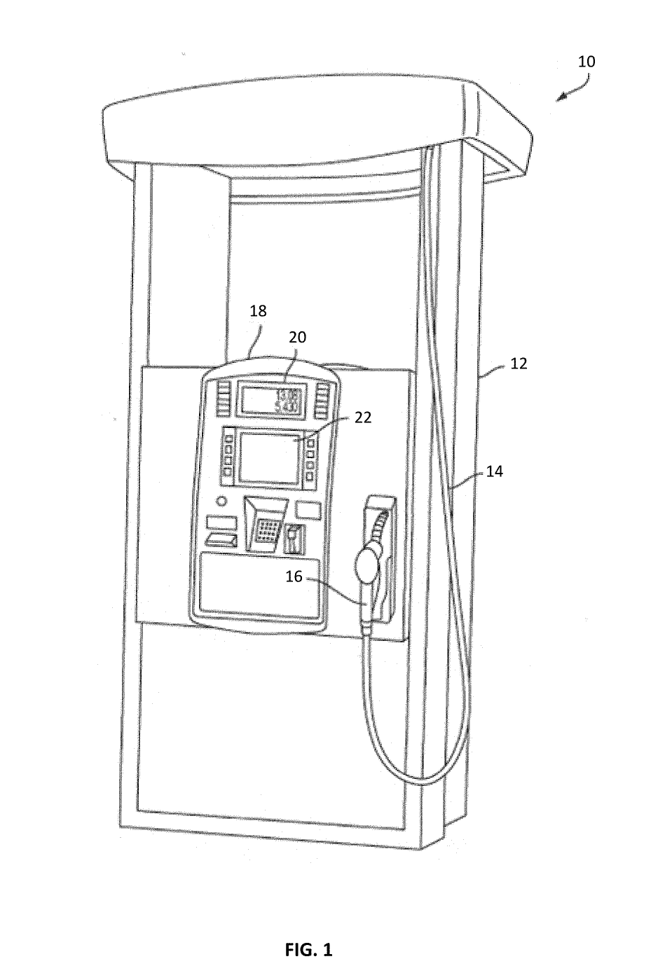

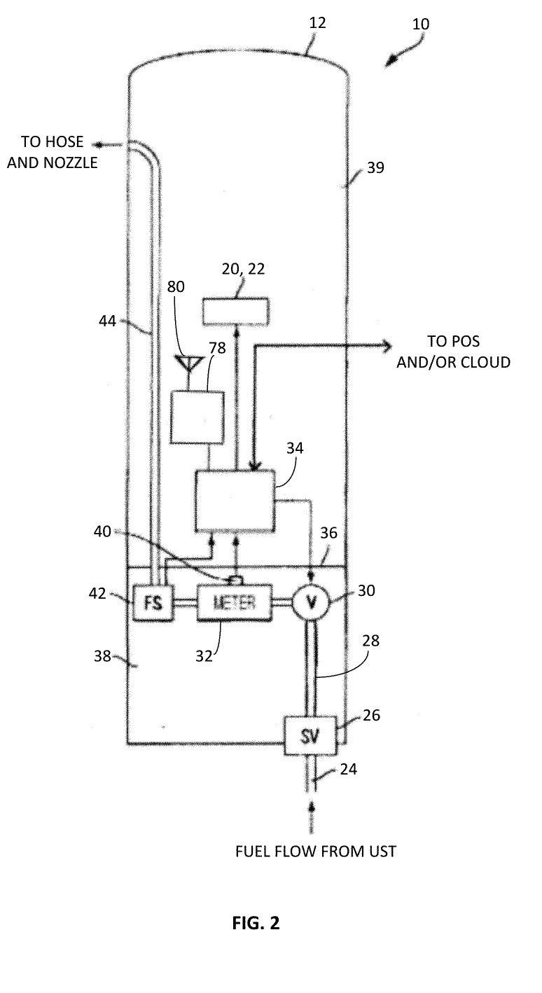

Referring now to FIGS. 1 and 2, a fuel dispenser 10 in accordance with an embodiment of the present invention will be described. One skilled in the art will recognize that many of aspects of fuel dispenser 10 are conventional, and similar to aspects described above in relation to the prior art. However, as will be explained more fully below, fuel dispenser 10 comprises electronics that provide internet connectivity and also communicate on an ad hoc basis with a vehicle in its proximity. As a result, the vehicle may establish a secure link with a vehicle manufacturer server or the like to obtain bulk transfer of data during a fueling transaction. In preferred embodiments, the fuel dispenser can thus serve to provide a shared OEM-agnostic method of distribution, serving as a trusted and secure endpoint connection/link between vehicle and OEM manufacturer.

Various advantages can be realized as a result. Notably, the vast majority of vehicles utilizing petroleum fuel (excluding that small percentage of depot-serviced vehicles) are by nature constrained to refueling at a retail petroleum dispenser. In addition, the dwell time at the fuel dispenser typically exceeds several minutes, which is sufficient for vehicle status query, distribution of software in full or large part, and/or for distribution of other informational data in full or large part. Furthermore, with the fuel dispenser (or facility providing fuel dispenser groupings) nominally connected to the internet via secure encrypted tunnel or similar method, a fuel dispenser in accordance with the present invention may furthermore have secure 802.11p connectivity (or the like) to implement query and update services on behalf of an OEM or other authorized entity at the fuel dispenser.

Referring again to FIG. 1, fuel dispenser 10 includes a housing 12 with a flexible fuel hose 14 extending therefrom. Fuel hose 14 terminates in a manually-operated nozzle 16 adapted to be inserted into a fill neck of a vehicle's fuel tank. Nozzle 16 includes a fuel valve. As will be described more fully below with reference to FIG. 2, various fuel handling components, such as valves and meters, are also located inside of housing 12. These fuel handling components allow fuel to be received from underground piping and delivered through hose 14 and nozzle 16 to a vehicle's tank, as is well understood.

Fuel dispenser 10 has a customer interface 18. Customer interface 18 may include an information display 20 relating to an ongoing fueling transaction that includes the amount of fuel dispensed and the price of the dispensed fuel. Further, customer interface 18 may include a display 22 that provides instructions to the customer regarding the fueling transaction. Display 22 may also provide advertising, merchandising, and multimedia presentations to a customer, and may allow the customer to purchase goods and services other than fuel at the dispenser.

FIG. 2 is a schematic illustration of internal fuel flow components of fuel dispenser 10 according to an embodiment of the present invention. In general, fuel may travel from an underground storage tank (UST) via main fuel piping 24, which may be a double-walled pipe having secondary containment as is well known, to fuel dispenser 10 and nozzle 16 for delivery. More specifically, a submersible turbine pump (STP) associated with the UST is used in this embodiment to pump fuel to the fuel dispenser 10. However, some fuel dispensers may be self-contained, meaning fuel is drawn to the fuel dispenser 10 by a pump unit positioned within housing 12.

Main fuel piping 24 passes into housing 12 through a shear valve 26. As is well known, shear valve 26 is designed to close the fuel flow path in the event of an impact to fuel dispenser 10. Shear valve 26 contains an internal fuel flow path to carry fuel from main fuel piping 24 to internal fuel piping 28.

After fuel exits the outlet of shear valve 26 and enters into internal fuel piping 28, it flows toward a flow control valve 30 positioned upstream of a flow meter 32. Alternatively, valve 30 may be positioned downstream of the flow meter 32. In one embodiment, valve 30 may be a proportional solenoid controlled valve, such as described in U.S. Pat. No. 5,954,080, hereby incorporated by reference in its entirety for all purposes.

Flow control valve 30 is under control of a control system 34. Control system 34 typically controls aspects of fuel dispenser 10, such as valves, displays, and the like. For example, control system 34 instructs flow control valve 30 to open when a fueling transaction is authorized. In addition, control system 34 may be in electronic communication with a POS located at the fueling site and/or various remote servers (i.e., the “cloud”) as needed or desired, including an OEM server to provide bulk data transfer to a vehicle being fueled. The POS communicates with control system 34 to control authorization of fueling transactions and other conventional activities.

A vapor barrier 36 separates hydraulics compartment 38 and electronics compartment 39 of fuel dispenser 10. As shown, control system 34 is located in electronics compartment 39 above vapor barrier 36. Fluid handling components, such as flow meter 32, are located in hydraulics compartment 38. In this regard, flow meter 32 may be any suitable flow meter known to those of skill in the art, including positive displacement, inferential, and Coriolis mass flow meters, among others. Meter 32 typically comprises electronics 40 that communicate information representative of the flow rate or volume to control system 34. For example, electronics 40 may include a pulser or other suitable displacement sensor as known to those skilled in the art. In this manner, control system 34 can update the total gallons (or liters) dispensed and the price of the fuel dispensed on information display 20.

As fuel leaves flow meter 32 it enters a flow switch 42, which preferably comprises a one-way check valve that prevents rearward flow through fuel dispenser 10. Flow switch 42 provides a flow switch communication signal to control system 34 when fuel is flowing through flow meter 32. The flow switch communication signal indicates to control system 34 that fuel is actually flowing in the fuel delivery path and that subsequent signals from flow meter 32 are due to actual fuel flow. Fuel from flow switch 42 exits through internal fuel piping 44 to fuel hose 14 and nozzle 16 for delivery to the customer's vehicle.

A blend manifold may also be provided downstream of flow switch 42. The blend manifold receives fuels of varying octane levels from the various USTs and ensures that fuel of the octane level selected by the customer is delivered. In addition, fuel dispenser 10 may in some embodiments comprise a vapor recovery system to recover fuel vapors through nozzle 16 and hose 14 to return to the UST. An example of a vapor recovery assist equipped fuel dispenser is disclosed in U.S. Pat. No. 5,040,577, incorporated by reference herein in its entirety for all purposes.

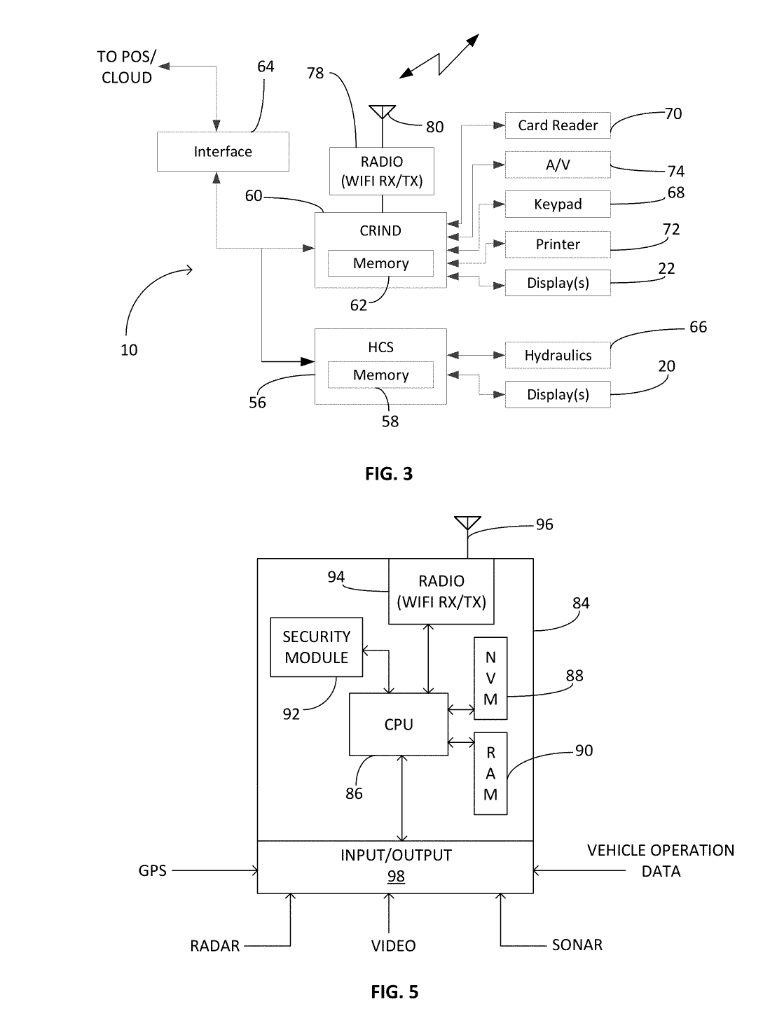

Certain additional details regarding the various components of fuel dispenser 10 will be explained with reference to FIG. 3. In this regard, control system 34 includes a hydraulic control system (“HCS”) 56 having an associated memory 58. In addition, control system 34 may also comprise a CRIND (card reader in dispenser) assembly 60 and associated memory 62. Those of ordinary skill in the art are familiar with CRIND units used in fuel dispensers, but additional background information is provided in U.S. Pat. No. 4,967,366, the entirety of which is incorporated herein by reference for all purposes. As shown, HCS 56 and CRIND assembly 60 are in operative communication with the POS of the fueling environment and/or one or more remote servers via an interface 64.

HCS 56 includes the hardware and software necessary to control the hydraulic components and functions of dispenser 10. Those of ordinary skill in the art are familiar with the operation of the hydraulics (collectively indicated at 66) of dispenser 10. In this regard, meter flow measurements from the pulser are collected by HCS 56. HCS 56 also typically performs calculations such as cost associated with a fuel dispensing transaction. HCS 56 may further be operative to control displays 20 provided on respective sides of fuel dispenser 10.

CRIND assembly 60 includes the hardware and software necessary to support payment processing and peripheral interfaces at dispenser 10. In this regard, CRIND assembly 60 may be in operative communication with several input devices. For example, a PIN pad 68 is typically used for entry of a PIN if the customer is using a debit card for payment of fuel or other goods or services. CRIND assembly 60 may also be in operative communication with a card reader 70 for accepting credit, debit, or other payment cards (e.g., magnetic stripe and/or chip cards). Additionally, card reader 70 may accept loyalty or program-specific cards as is well known. Further, CRIND assembly 60 may be in operative communication with other payment or transactional devices such as a receipt printer 72.

As noted above, display(s) 22 may be used to display information, such as transaction-related prompts and advertising, to the customer. Again, two such displays would typically be provided, one on each side of a two-sided dispenser. The customer may use soft keys to respond to information requests presented to the user via a display 22. In some embodiments, however, a touch screen may be used for a display 22.

Audio/video electronics 74 are adapted to interface with the CRIND assembly 60 and/or an auxiliary audio/video source to provide advertising, merchandising, and multimedia presentations to a customer in addition to basic transaction functions. The graphical user interface provided by the dispenser may allow customers to purchase goods and services other than fuel at the dispenser. For example, the customer may purchase a car wash and/or order food from the store while fueling a vehicle.

Conventionally, a user positions a vehicle adjacent to one of dispensers 10 and uses the dispenser to refuel the vehicle. For payment, the user inserts and removes a payment card from card reader 70. Card reader 70 reads the information on the payment card which is then transmitted, such as via a POS system, to a financial institution's host server for approval. The financial institution either validates or denies the transaction and transmits such a response. If the transaction is approved, dispensing of fuel is allowed.

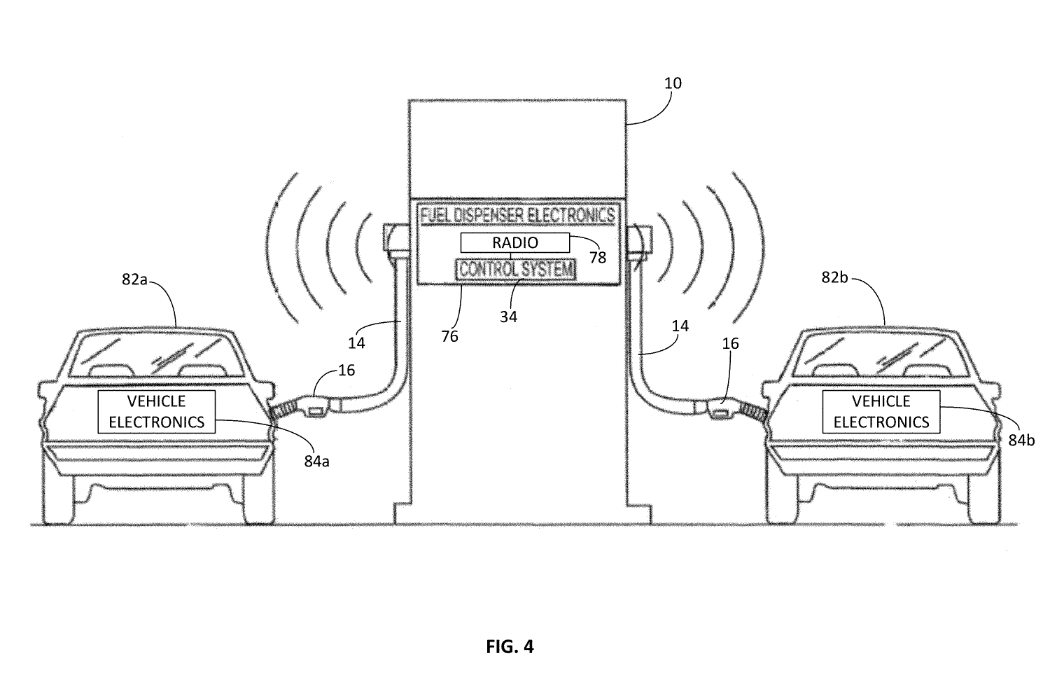

Referring now also to FIG. 4, the electronics 76 of fuel dispenser 10 are equipped with circuitry, i.e., radio 78 (which includes one or more suitable antenna(e) 80 as shown in FIG. 3), that allows for the creation of ad hoc wireless networks on a one-to-one basis with vehicles being refueled. For example, in a preferred embodiment, radio 78 (either built into or proximate to the remainder of fuel dispenser 10) may provide wireless connectivity with the vehicle in accordance with standard 802.11p. In this regard, a pair of vehicles 82a-b are shown adjacent to fuel dispenser 10 in the refueling position. Nozzles 14 are inserted into the fill necks of the respective vehicle's fuel tank to receive fuel when authorized dispensing has begun. In this case, both of vehicles 82a-b are equipped with vehicle electronics 84a-b allowing the creation of an ad hoc network with a suitably equipped fuel dispenser.

More detail regarding vehicle electronics 84 can be explained with reference to FIG. 5. Typically, vehicle electronics 84 may be embodied as a high-performance automotive processor, such as those available from NXP Semiconductors located in Austin, Tex. For example, the NXP S32V234 Processor may be utilized for this purpose. Such a device typically has a secure “side” which limits receipt of updates and other data from trusted sources per ISO 26262. In this regard, vehicle electronics 84 includes a central processing unit (CPU) 86 that communicates with a non-volatile memory (NVM) 88 and a volatile working memory 90 (labeled “RAM”). Security module 92 contains the keys or other authentication indicia necessary to identify vehicle electronics 84 to the OEM server, and vice versa, as well as to provide encrypted communication therebetween. Radio 94 (with associated antenna(e) 96) provides wireless connectivity with other vehicles and trusted RSUs, such as fuel dispenser 10.

Vehicle circuitry 84 further includes input/output hardware and firmware (indicated collectively at 98) to receive information from various sensors and other systems on the vehicle. As shown, this may include vehicle operation data, sonar data, video data, radar data, and/or GPS data, and the like.

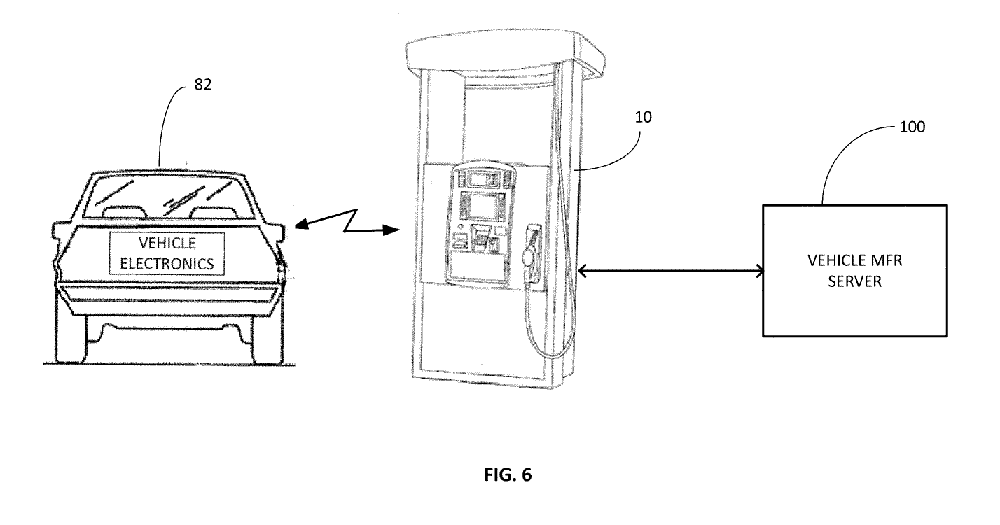

Referring now to FIG. 6, a preferred embodiment of fuel dispenser 10 provides a secure link, compliant with the 802.11p standard, between vehicle 82 and a remote server 100 from which vehicle data may be downloaded. In particular, after the secure link is established, server 100 may query vehicle status to determine which updates or other data to transfer. Available patches and other updates may thereby be distributed to the vehicle using the sufficient dwell inherent in the refueling process. In addition to software updates, information transferred to or from the vehicle during this time may include:
Information regarding road conditions, weather, map updates, etc.
Notifications/reminders by OEM manufacturer.
Upload of vehicle status and system health.
Upload of vehicle operational statistics.
   Notably, the data in this case comprises data necessary or useful for operation or monitoring of the vehicle but is otherwise unrelated to the ongoing refueling operation.

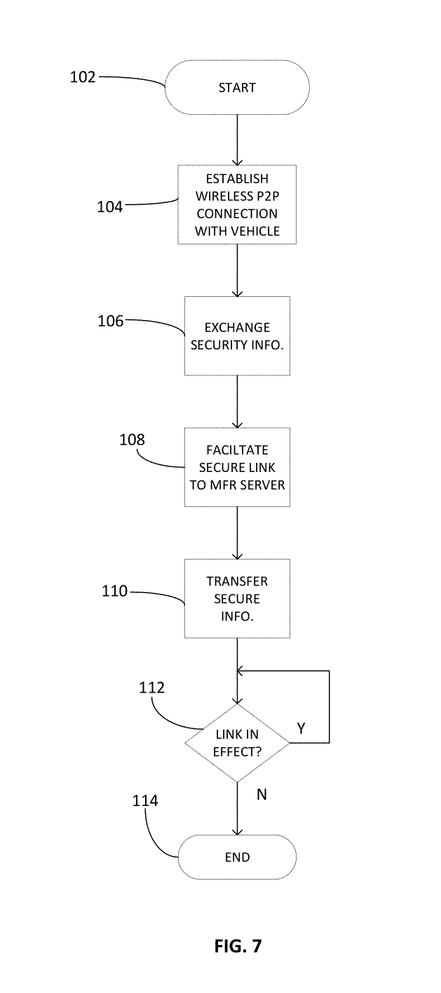

FIG. 7 illustrates a process, implemented from the standpoint of the fuel dispenser, for transferring information on a secure basis between a vehicle and a remote server, such as an update server provided by the vehicle's manufacturer. After the process begins (as indicated at 102), the fuel dispenser establishes a wireless peer-to-peer (“P2P”) connection on an ad hoc basis between the fuel dispenser and the vehicle (as indicated at 104). Security information is provided to the vehicle by the fuel dispenser, as indicated at 106, so that the vehicle recognizes the fuel dispenser as a trusted RSU which may be used to establish a connection with the remote server. As will be appreciated, the security information may be provided by or to the OEM in advance in order for the fuel dispenser's trusted status to be recognized by the vehicle. Next, as indicated at 108, the fuel dispenser facilitates a secure link between vehicle 84 and server 100, such as via secure socket layer (SSL) or similar secure protocol.

After the secure link is established, server 100 typically queries vehicle 84 to determine the status of its software and/or other information. Depending on the query, selected information may be provided to or from vehicle 84 via the secure link (as indicated at 110). The fuel dispenser serves as a conduit for this data transfer while the secure link is in effect. When the fuel dispenser determines that the secure link is no longer in effect (as indicated at 112), the process ends (as indicated at 114).

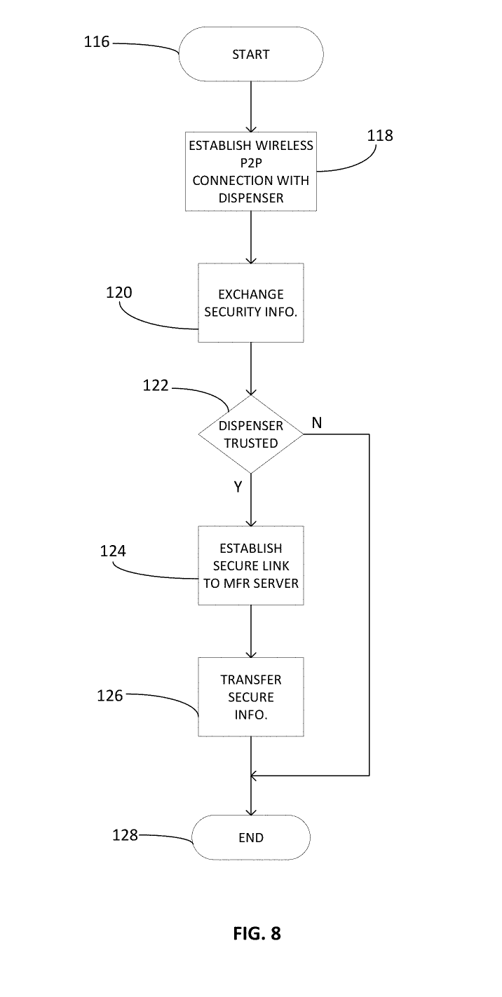

FIG. 8 illustrates the process of FIG. 7, but implemented from the standpoint of the vehicle. After the process begins (as indicated at 116), a wireless P2P connection is established with the fuel dispenser on an ad hoc basis (as indicated at 118). Security information is received from the fuel dispenser (as indicated at 120), so that the vehicle recognizes the fuel dispenser as a trusted RSU (as indicated at 122) which may be used to establish a connection with the remote server. If the dispenser is found to be “trusted,” the vehicle establishes a secure link with server 100 (as indicated at 124). Typically, server 100 will then query the vehicle to determine what information needs to be transferred, at which point the appropriate information is distributed to the vehicle (as indicated at 126). The process ends at 128.

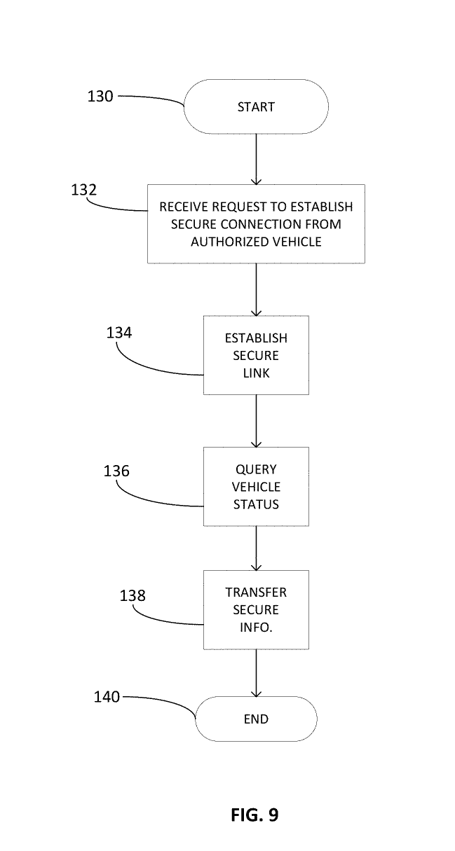

FIG. 9 illustrates the process of FIG. 7, but implemented from the standpoint of the remote server 100. After the process begins (as indicated at 130), the remote server receives a request from the vehicle, facilitated by the fuel dispenser, to establish a secure connection (as indicated at 132). If the request is determined to be authentic, a secure link is established with the vehicle (as indicated at 134). Server 100 will then typically query the vehicle to determine what information needs to be transferred (as indicated at 136). Based on this determination, the appropriate information is distributed to the vehicle (as indicated at 138). The process ends at 140.

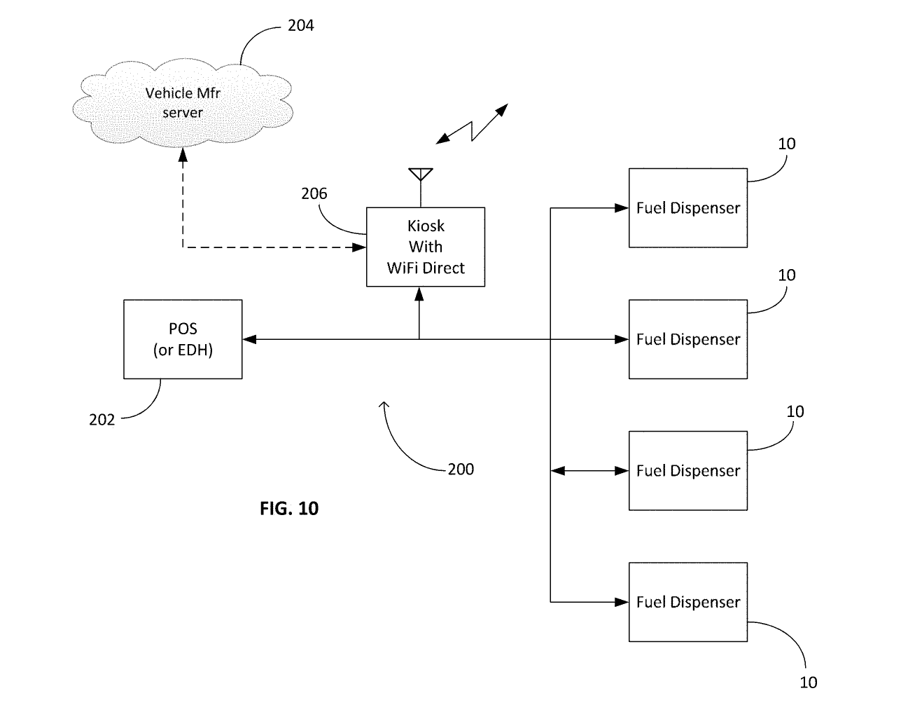

As noted above, the network circuitry may be proximate to the fuel dispenser rather than being incorporated into the fuel dispenser. An example is shown in FIG. 10, which illustrates a retail fuel dispensing environment 200 having a plurality of fuel dispensers 10 located in its forecourt region. As shown, fuel dispensers 10 are in communication with a point of sale system (POS) 202. (Alternatively, an enhanced dispenser hub, or “EDH,” as disclosed in U.S. Pat. No. 8,438,064, may communicate with the dispensers 10 and a remote host, in which case the POS would be a separate device in communication with the EDH.) As also shown, communication with a vehicle manufacturer server 204 (either directly or via POS 202) is provided by a separate infrastructure-to-vehicle network device, here in the form of kiosk 206, which is operative to establish ad hoc peer-to-peer networks with vehicles in the forecourt. Kiosk 206 preferably communicates with the respective one of fuel dispensers 10 with which each of the vehicles is respectively associated and, along with the various fuel dispensers 10, effects functionality as otherwise described above.

It can thus be seen that the present invention provides fuel dispensing equipment and related methodology that achieves various advantages in comparison with the prior art. These include:
User interaction with the petroleum equipment enhances safe or corrected vehicle operation; vehicle receives fully or in part software updates as determined by the OEM.
Reduced cost of data distribution method, as presence of secure 802.11p may also be utilized to enhance and/or automate refueling of the vehicle for those vehicles so equipped.
Dispenser serves as a largely inescapable nexus point for all vehicles requiring fuel (all non 100% electric vehicles).

While one or more preferred embodiments of the invention have been described above, it should be understood that any and all equivalent realizations of the present invention are included within the scope and spirit thereof. Thus, the embodiments depicted are presented by way of example only and are not intended as limitations upon the present invention as modifications can be made. Therefore, it is contemplated that any and all such embodiments are included in the present invention as may fall within the scope and spirit thereof.

What is claimed is:

1. A fuel dispenser comprising:
fuel flow piping defining a flow path from a source of fuel toward a fueling nozzle;
a plurality of fuel handling components disposed along said fuel flow piping;
control electronics in operative communication with said fluid handling components;
said fuel dispenser including network circuitry operative to create an ad hoc wireless network with an adjacent vehicle and, after creation of such network, exchange security indicia with said vehicle identifying said fuel dispenser as a trusted road side unit; and
said fuel dispenser thereafter facilitating a communication link with a remote server for bulk data transfer to said vehicle of information unrelated to a fueling transaction.

2. A fuel dispenser as set forth in claim 1, wherein said remote server comprises a server associated with a manufacturer of said adjacent vehicle.

3. A fuel dispenser as set forth in claim 2, wherein said information unrelated to a fueling transaction includes software updates for said adjacent vehicle.

4. A fuel dispenser as set forth in claim 2, wherein said network circuitry communicates with in range vehicles and determines whether one of said vehicles is said adjacent vehicle based on said location information.

5. A fuel dispenser as set forth in claim 1, wherein said network circuitry creates a VANET with said adjacent vehicle.

6. A fuel dispenser as set forth in claim 1, wherein said fuel dispenser is operative to monitor whether said communication link remains in effect.

7. A fuel dispensing environment comprising:
a plurality of fuel dispensers, each of the dispensers having:
fuel flow piping defining a flow path from a source of fuel toward a fueling nozzle;
a plurality of fuel handling components disposed along said fuel flow piping;
control electronics in operative communication with said fluid handling components; and
an infrastructure to vehicle network device in communication with each of said fuel dispensers, said device including network circuitry operative:
to create a wireless peer to peer network with vehicles in the forecourt and associate each such vehicle with one of said fuel dispensers, and
after creation of such network, exchange security indicia with said vehicle identifying said infrastructure to vehicle network device as a trusted road side unit thereafter facilitating a communication link with a remote server for bulk data transfer to said vehicle of information unrelated to a fueling transaction.

8. A fuel dispensing environment as set forth in claim 7, wherein said remote server comprises a server associated with a manufacturer of said vehicle.

9. A fuel dispensing environment as set forth in claim 8, wherein said information unrelated to a fueling transaction includes software updates for said vehicle.

10. A fuel dispensing environment as set forth in claim 7, wherein said network circuitry creates a VANET with one or more of said vehicles.

11. A fuel dispensing environment as set forth in claim 7, wherein said infrastructure to vehicle network device is operative to monitor whether each of said communication links remain in effect.

12. A method utilized at a fuel dispenser to wirelessly provide bulk data transfer of information in electronic form to an adjacent vehicle which is unrelated to a fueling transaction, said method comprising steps of:
(a) communicating with said vehicle when within communication range of said fuel dispenser;
(b) determining whether said vehicle is in a dispensing location adjacent to said fuel dispenser;
(c) if said vehicle is in said dispensing location, establishing a VANET between said fuel dispenser and said vehicle;
(d) providing security indicia to said vehicle identifying said fuel dispenser as a trusted road side unit; and
(e) establishing a communication link between said vehicle and a remote server to provide software updates for said vehicle.
